(19) United States
(12) Patent Application Publication
(10) Pub. No.: US 2010/0253804 A1
(43) Pub. Date: Oct. 7, 2010

(54) METHOD OF STORING IMAGE DATA, DIGITAL PHOTOGRAPHING APPARATUS, METHOD OF CONTROLLING DIGITAL PHOTOGRAPHING APPARATUS, AND RECORDING MEDIUM STORING PROGRAM TO EXECUTE THE CONTROLLING METHOD

(76) Inventor: Myung-hun Lee, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(21) Appl. No.: 12/748,962

(22) Filed: Mar. 29, 2010

(30) Foreign Application Priority Data
Apr. 2, 2009 (KR) 10-2009-0028542

(51) Int. Cl. H04N 5/76

(52) U.S. Cl. 348/231.2; 348/E05.031

(57) ABSTRACT

There are provided a method of storing image data, a digital photographing apparatus, a method of controlling a digital photographing apparatus, and a recording medium storing a program to execute the controlling method, for storing image data as a small-size file without degradation of image quality at main parts of the image data. According to the method of storing image data, the digital photographing apparatus, the method of controlling a digital photographing apparatus, and the recording medium storing a program to execute the controlling method, image data are stored in a state where first and second regions of an image corresponding to the image data have different image quality levels.

### CROSS-REFERENCE TO RELATED PATENT APPLICATION

This application claims the benefit of Korean Patent Application No. 10-2009-0028542, filed on Apr. 2, 2009, in the Korean Intellectual Property Office, the disclosure of which is incorporated herein in its entirety by reference.

### BACKGROUND

The present invention relates to a method of storing image data, a digital photographing apparatus, a method of controlling a digital photographing apparatus, and a recording medium storing a program to execute the controlling method, and more particularly, to a method of storing image data, a digital photographing apparatus, a method of controlling a digital photographing apparatus that allow storing of image data as a small-size file without degradation of image quality at main parts of an image, and a recording medium storing a program to execute the controlling method.

In a conventional photographing apparatus, image data are obtained from light incident on an imaging device, and the obtained image data are stored in a storage medium, such as a file, or displayed on a display device.

In such a conventional digital photographing apparatus, the size of a file to be stored in a storage medium can be selected by a user, and the quality of an image reproduced from the file data is determined according to the file size selected. For example, when data are stored in the storage medium, a user can select an option, such as small (S), medium (M), or large (L). If the user selects the S option, the data are stored in the storage medium as a small-size file. If the user selects the M option, the data are stored in the storage medium as a medium-size file. If the user selects L option, the data are stored in the storage medium as a large-size file.

That is, the size of a file stored in the storage medium relates to the image quality of the file data. For example, if the size of a file is small, the quality of an image reproduced from the file data is relatively poor. However, if data are stored in the storage medium as a large-size file to improve the quality of an image reproduced from the file data, the number of files that can be stored in the storage medium is reduced due to the limited capacity of the storage medium. In the case where data are stored in the storage medium as a small-size file, a user may not be satisfied due to poor image quality as mentioned above.

### SUMMARY

The present invention provides a method of storing image data, a digital photographing apparatus, a method of controlling a digital photographing apparatus, and a recording medium storing a program to execute the controlling method, which allow storing of image data as a small-size file without degradation of image quality of the main parts of the image.

According to an aspect of the present invention, there is provided a method of storing image data, the method including storing image data in a state where the first and second regions of an image corresponding to the image data have different image quality levels.

If the image includes a face region, the first region may include the face region. In another embodiment, if the image includes a face region, the first region may include the face region and a body region extending from the face region.

At least one of the first and second regions may be selected by a user. The image data may be sorted in a state where the first region has an image quality level higher than that of the second region. A portion of high-frequency components may be removed from the second region of the image data to store the image data in a state where the first region has an image quality level higher than that of the second region.

According to another aspect of the present invention, there is provided a method of controlling a digital photographing apparatus configured to generate image data from light incident on an imaging device and store the image data in a storage medium, the method including storing the image data in the storage medium in a state where first and second regions of an image corresponding to the image data have different image quality levels.

If the image includes a face region, the first region may include the face region. In another embodiment, if the image includes a face region, the first region may include the face region and a body region extending from the face region.

The first region may include a focused region. At least one of the first and second regions may be selected by a user. The image data may be sorted in a state where the first region has an image quality level higher than that of the second region. A portion of a high-frequency component may be removed from the second region of the image data to store the image data in a state where the first region has an image quality level higher than that of the second region.

According to another aspect of the present invention, there is provided a recording medium storing a program for executing the method.

According to another aspect of the present invention, there is provided a digital photographing apparatus including: an imaging device configured to generate image data from incident light; and a storage medium configured to store the image data generated by the imaging device, wherein the image data is stored in the storage medium in a state where first and second regions of an image corresponding to the image data have different image quality levels.

The digital photographing apparatus may further include a face determination unit configured to determine whether a face is included in a scene to be captured, wherein if the image includes a face region, the first region may include the face region.

The digital photographing apparatus may further includes a face determination unit configured to determine whether a face is included in a scene to be captured, wherein if the image includes a face region, the first region may include the face region and a body region extending from the face region.

At least one of the first and second regions may be selected by a user. The first region may include a focused region. The image data may be sorted in a state where the first region has an image quality level higher than that of the second region.

A portion of a high-frequency component may be removed from the second region of the image data to store the image data in a state where the first region has an image quality level higher than that of the second region.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram illustrating a digital photographing apparatus according to an embodiment of the present invention;

FIGS. 2 and 3 are pictorial diagrams illustrating exemplary images captured by the digital photographing apparatus of FIG. 1; and

FIG. 4 is a schematic block diagram illustrating a digital photographing apparatus according to another embodiment of the present invention.

### DETAILED DESCRIPTION OF THE EMBODIMENTS

The present invention will now be described more fully with reference to the accompanying drawings, in which exemplary embodiments of the invention are shown.

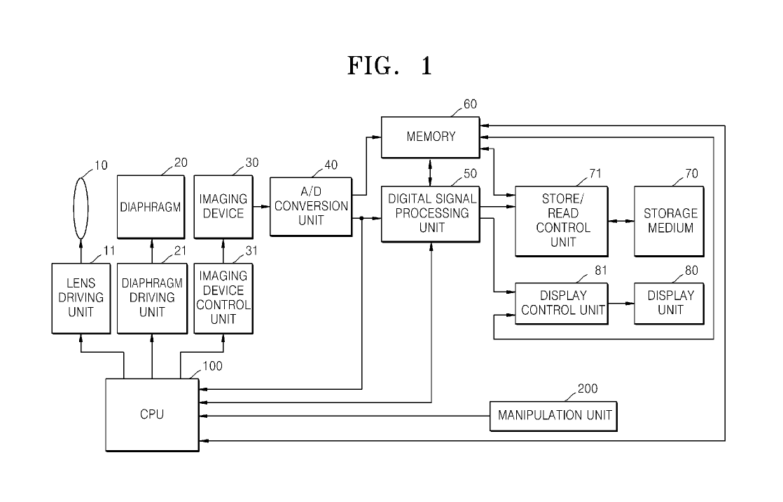

FIG. 1 is a schematic block diagram illustrating a digital photographing apparatus according to an embodiment of the present invention.

The overall operation of the digital photographing apparatus is controlled by a central processing unit (CPU) 100. The digital photographing apparatus includes a manipulation unit 200, and the manipulation unit 200 includes a device such as a key that generates an electric signal in response to a users manipulation. For example, when an electric signal is transmitted from the manipulation unit 200 to the CPU 100, the CPU 100 controls the digital photographing apparatus according to the electric signal.

In a photographing mode, an electric signal generated according to a user's manipulation is transmitted to the CPU 100, and the CPU 100 controls a lens driving unit 11, a diaphragm driving unit 21, and an imaging device control unit 31 according to the electric signal, so as to adjust the position of a lens 10, the opening of a diaphragm 20, and the sensitivity of an imaging device 30, for example. The imaging device 30 extracts data corresponding to input light, and an analog/digital conversion unit 40 converts analog data from the imaging device 30 into digital data. According to the type of the imaging device 30, the analog/digital conversion unit 40 may be unnecessary.

Data obtained by the imaging device 30 may be transmitted to a digital signal processing unit 50 directly or through a memory 60, and if necessary, the data may be input to the CPU 100. Herein, the word “memory” is a term including a read only memory (ROM) and a random access memory (RAM). The digital signal processing unit 50 may be used for digital signal processing such as gamma correction and white balancing.

Data output from the digital signal processing unit 50 may be transmitted to a display control unit 81 directly or through the memory 60. The display control unit 81 may control a display unit 80 so as to display the received data as an image. In addition, the data output from the digital signal processing unit 50 may be input to a store/read control unit 71 directly or through the memory 60, and the store/read control unit 71 may store the data in a storage medium 70 automatically or according to a signal input by a user. The store/read control unit 71 may read data from a file stored in the storage medium 70 and transmit the read data to the display control unit 81 through the memory 60 or another route for displaying the data on the display unit 80 in the form of an image. The storage medium 70 may be detachably or non-detachably mounted on the digital photographing apparatus.

In the above-described digital photographing apparatus of the current embodiment, image data can be stored in the storage medium 70 in a state where the first and second regions of an image corresponding to the image data have different quality levels. For example, when image data are stored in the storage medium 70, a region of interest (ROI) of the image may be stored as a first region having a high image quality level, and other regions may be stored as a second region having an image quality level lower than that of the first region, so as to reduce the size of the image data (file) stored in the storage medium 70 while satisfying a user's demand for a high-quality image.

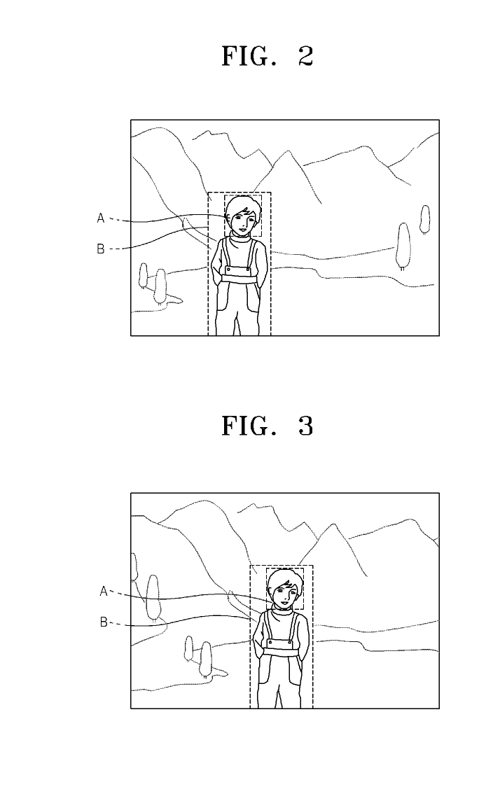

The ROI (first region) can be determined in various ways. FIG. 2 is a schematic view illustrating an exemplary image reproduced from image data obtained by the digital photographing apparatus of FIG. 1. As shown in FIG. 2, if a person's face is included in the image, a user may want the person's face to be clearer than other regions in the image. Thus, in this case, a region (A), which includes a person's face, may be selected as a first region.

For setting the region (A) as the first region, it is necessary to detect the person's face region in the image. Various methods can be used to detect the face region in the image. For example, the face region can be detected by determining whether the image includes colors corresponding to a person's face based on previously stored data regarding colors corresponding to persons' faces. In another example, the face region can be detected by determining whether the image includes an eye pupil shape or an eye shape based on previously stored data regarding eye pupil shapes or eye shapes. In another example, the face region can be detected by determining whether the image includes a T-shape based on previously stored data regarding T-shapes formed by eyebrows (or eyes) and a nose.

After detecting a person's face region in the image as described above, the region (A) including the person's face region is set as the first region, and the image data are stored in the storage medium 70 in a state where the first region of the image has an image quality level different from (higher than) the image quality level of other regions/areas (second region) of the image. Therefore, the size of the image data stored in the storage medium 70 can be significantly reduced while satisfying a user's expectation for a high-quality image.

Some users may want a person's body as well as his/her face, included in an image region, to be clearer than other regions of the image. Therefore, when image data including a person's face region are stored in the storage medium 70, a region (B) including the face region and a body region extending from the face region may be set as a first region. The face region can be detected as described above, and the body region can be detected by various methods such as a method of determining a region having a predetermined size and direction from the detected face region as a body region. For example, if the face region is detected from the image based on information about an eye pupil shape, an eye shape, or a T-shape formed by eyebrows (or eyes) and a nose, the direction of a line passing through the nose and mouth in the face in the image can be determined based on the same information. After determining the direction of the line in the face, it can be taken into account that the body is located in a predetermined direction from the face and the size of the body is proportional to the size of the face. In this way, the region (B) including a face region and a body region can be set as the first region.

Generally, a user may manipulate the digital photographing apparatus to focus an ROI. Therefore, in this case, a first region may be defined to include the focused ROI, and image data may be stored in the storage medium 70 in a condition that the first region of an image corresponding to the image data has an image quality level different from (higher than) that of other regions (second region), so as to reduce the size of the image data stored in the storage medium 70 while maintaining the image quality of the image data at an acceptable level for satisfying a users demand for a high-quality image. For example, a region having a predetermined size and centered on the center of a focused region may be set as a first region.

In a photographing mode, live-view moving images (real-time moving images) may be displayed on the display unit 80 so that a user can easily frame a scene. In this case, if the display unit 80 is a touch-screen display unit, a user can set a first region or a second region by touching and/or dragging on a desired screen region of the display unit 80. For example, if a user touches a point on the screen of the display unit 80, a region having a predetermined size and centered on the touched point may be set as a first region. In this way, at least one of first and second regions may be set by a user.

Image data can be stored in the storage medium 70 in a state where a first region of the image has an image quality level different from (higher than) that of other regions (second region) by removing a portion of high-frequency components from the second region of the image data. In this case, since humans are less sensitive to a high-frequency component of an image than to a low-frequency component, the image quality degradation of the second region may be less perceived by the human eye.

After an ROI is set, a user can move the digital photographing apparatus to change frames and so on. For example, after setting the region (A) or (B) as an ROI as shown in FIG. 2, a user can move the digital photographing apparatus to change the scene as shown in FIG. 3. For this case, the digital photographing apparatus may further include a gyro-sensor to detect the movement of the digital photographing apparatus so as not to re-define the ROI on the scene of FIG. 3, but to maintain the region (A) or (B) as the ROI on the scene of FIG. 3 by automatically chasing the region (A) or (B) from the scene of FIG. 2 to the scene of FIG. 3 according to the movement of the digital photographing apparatus. Other methods not using a gyro-sensor can be used. For example, motion vectors of frames of live-view moving images (real-time moving images) or motion vectors of objects in the frames may be used to maintain an ROI at the same position of an object although the digital photographing apparatus or the object is moved.

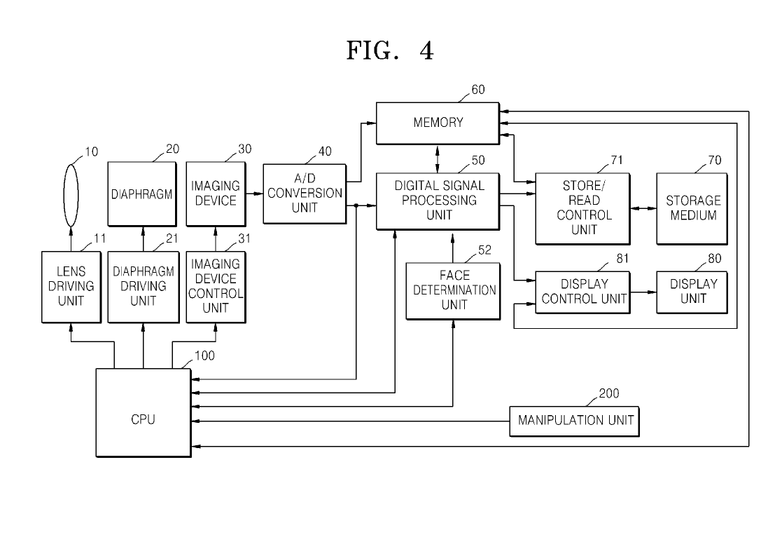

FIG. 4 is a schematic block diagram illustrating a digital photographing apparatus according to another embodiment of the present invention. The embodiment of the digital photographing of FIG. 4 has the same structure as that of the digital photographing apparatus of FIG. 1 except that the digital photographing apparatus further includes a face determination unit 52. As explained above, in the case where an image including a person's face is captured, a user may want the person's face to be clearer than other regions of the image. Thus, in this case, a region including the person's face may be selected as a first region. For this end, the face determination unit 52 determines whether a person's face is included in a scene (object) to be captured. The determination by the face determination unit 52 may be performed as described above. That is, the face determination unit 52 may analyze frames of live-view moving images (real-time moving images), and by using the above-described method, the face determination unit 52 may determine whether a person's face is included in a target scene (object) to be captured. If the face determination unit 52 determines that a person's face is included in the target scene, the face determination unit 52 may detect a region of the target scene where the person's face is located. In the embodiment of FIG. 4, the face determination unit 52 is illustrated as an independent element. However, the face determination unit 52 may be provided as a part of the digital signal processing unit 50 or other units.

As another embodiment of the present invention, there may be provided a method of controlling a digital photographing apparatus for generating image data from light incident on an imaging device and storing the image data in a storage medium. In the digital photographing apparatus controlling method, image data may be stored in the storage medium in a state where first and second regions of an image corresponding to the image data have different image quality levels. That is, the first region (an ROI) of the image may be stored in the storage medium at a high image quality level, and the second region (other regions) of the image may be stored in the storage medium at an image quality level lower than that of the first region, for significantly reducing the size of an image data file stored in the storage medium while satisfying a user's demand for a high-quality image.

The ROI (first region) can be determined in various ways. For example, if a person's face is included in a captured image as shown in FIG. 2, a user may want the person's face to be clearer than other regions. Thus, in this case, a region (A) including the person's face may be selected as a first region. As described above, various methods can be used to detect the face region from the image.

Some users may want that a person's body as well as a face included in an image is clearer than other regions of the image. Therefore, when image data including a person's face region are stored in the storage medium, a region (B) including the face region and a body region extending from the face region may be set as a first region. The region (B) including the face region and the body region extending from the face region can be detected by various methods as described above.

Generally, a user may manipulate the digital photographing apparatus to focus an ROI. Therefore, in this case, a first region may be defined to include the focused ROI, and image data may be stored in the storage medium in a condition where the first region of the image has an image quality level different from (higher than) that of other regions (second region), so as to significantly reduce the size of the image data stored in the storage medium while maintaining the image quality of the image data at an acceptable level for satisfying a user's demand for a high-quality image.

At least one of first and second regions may be selected by a user. For example, if a display unit is a touch-screen display unit and capable of displaying live-view moving images (real-time moving images) in photographing mode, a user can set a first region or a second region by touching and/or dragging on a desired screen region of the display unit. For example, if a user touches a point on the screen of the display unit, a region having a predetermined size and centered on the touched point may be set as a first region. In this way, at least one of first and second regions may be set by a user.

Image data can be stored in the storage medium in a state where a first region of the image has an image quality level different from (higher than) that of other regions (second region) by removing a portion of high-frequency components from the second region of the image data. In this case, since humans are less sensitive to a high-frequency component of an image than to a low-frequency component, the image quality degradation of the second region may be less perceived by the human eye.

The controlling method described according to the embodiments and modifications thereof may be performed on a digital photographing apparatus by a program stored in a recording medium. The recording medium may be the storage medium 70 or the memory 60 shown in FIG. 1, or an additional recording medium. Examples of the recording medium include magnetic storage media (e.g., ROM, floppy disks, hard disks, etc.), and optical recording media (e.g., CD-ROMs, or DVDs).

As another embodiment of the present invention, there may be provided a method of storing image data in a condition that first and second regions of an image corresponding to the image data have different image quality levels. For example, the image data storing method of the current embodiment can be applied to various image processing apparatuses and/or image data storing apparatuses such as personal digital assistants (PDAs) and personal multimedia players (PMPs), for storing image data in a storage medium of such an apparatus in a state where first and second regions of the image data have different image quality levels. That is, the first region (an ROI) of the image may be stored at a high image quality level, and the second region (other regions) may be stored at an image quality level lower than that of the first region, so as to reduce the size of the image data significantly while satisfying a user's demand for a high-quality image.

The ROI (first region) can be determined in various ways. For example, if a person's face is included in a captured image as shown in FIG. 2, a user may want the person's face of the image to be clearer than other regions. Thus, in this case, a region (A) including the person's face may be selected as a first region. As described above, various methods can be used to detect the face region from the image.

Some users may want that a person's body as well as a face included in an image is clearer than other regions of the image. Therefore, when image data including a person's face region are stored in the storage medium, a region (B) including the face region and a body region extending from the face region may be set as a first region. The region (B) including the face region and the body region extending from the face region can be detected by various methods as described above.

At least one of first and second regions may be selected by a user. For example, if a display unit of an image processing apparatus is a touch-screen type display unit, a user can set a first region or a second region by touching and/or dragging on a desired screen region of the display unit. For example, if a user touches a point on the screen of the display unit, a region having a predetermined size and centered on the touched point may be set as a first region. In this way, at least one of first and second regions may be set by a user.

Image data can be stored in the storage medium in a state where a first region of the image has an image quality level different from (higher than) that of other regions (second region) by removing a portion of high-frequency components from the second region of the image data. In this case, since persons are less sensitive to a high-frequency component of an image than to a low-frequency component, the image quality degradation of the second region may be less perceived.

As described above, according to the method of storing image data, the digital photographing apparatus, the method of controlling a digital photographing apparatus, and a recording medium storing a program to execute the controlling method, image data can be stored as a small-size file without degradation of image quality at main parts of the image data.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

Numerous modifications and adaptations will be readily apparent to those skilled in this art without departing from the spirit and scope of the present invention.

What is claimed is:

1. A method of storing image data, comprising storing image data in a state where first and second regions of an image corresponding to the image data have different image quality levels.

2. The method of claim 1, wherein, if the image comprises a face region, the first region comprises the face region.

3. The method of claim 1, wherein, if the image comprises a face region, the first region comprises the face region and a body region extending from the face region.

4. The method of claim 1, wherein at least one of the first and second regions is selected by a user.

5. The method of claim 1, wherein the image data is sorted in a state where the first region has an image quality level higher than that of the second region.

6. The method of claim 5, wherein a portion of high-frequency components are removed from the second region of the image data to store the image data in a state where the first region has an image quality level higher than that of the second region.

7. A method of controlling a digital photographing apparatus configured to generate image data from light incident on an imaging device and store the image data in a storage medium, the method comprising storing the image data in the storage medium in a state where first and second regions of an image corresponding to the image data have different image quality levels.

8. The method of claim 7, wherein if the image comprises a face region, the first region comprises the face region.

9. The method of claim 7, wherein if the image comprises a face region, the first region comprises the face region and a body region extending from the face region.

10. The method of claim 7, wherein the first region comprises a focused region.

11. The method of claim 7, wherein at least one of the first and second regions is selected by a user.

12. The method of claim 7, wherein the image data is sorted in a state where the first region has an image quality level higher than that of the second region.

13. The method of claim 12, wherein a portion of a high-frequency component is removed from the second region of the image data to store the image data in a state where the first region has an image quality level higher than that of the second region.

14. A computer program product, comprising a computer usable medium having a computer readable program code embodied therein, the computer readable program code adapted to be executed to implement a method for controlling a digital photographing apparatus configured to generate image data from light incident on an imaging device and store the image data in a storage medium, the method comprising storing the image data in the storage medium in a state where first and second regions of an image corresponding to the image data have different image quality levels.

15. A digital photographing apparatus comprising:
an imaging device configured to generate image data from incident light; and
a storage medium configured to store the image data generated by the imaging device,
wherein the image data is stored in the storage medium in a state where first and second regions of an image corresponding to the image data have different image quality levels.

16. The digital photographing apparatus of claim 15, further comprising a face determination unit configured to determine whether a face is included in a scene to be captured,
wherein if the image comprises a face region, the first region comprises the face region.

17. The digital photographing apparatus of claim 15, further comprising a face determination unit configured to determine whether a face is included in a scene to be captured,
wherein if the image comprises a face region, the first region comprises the face region and a body region extending from the face region.

18. The digital photographing apparatus of claim 15, wherein at least one of the first and second regions is selected by a user.

19. The digital photographing apparatus of claim 15, wherein the first region comprises a focused region.

20. The digital photographing apparatus of claim 15, wherein the image data is sorted in a state where the first region has an image quality level higher than that of the second region.

21. The digital photographing apparatus of claim 20, wherein a portion of a high-frequency component is removed from the second region of the image data to store the image data in a state where the first region has an image quality level higher than that of the second region.
